(19) United States
(12) Patent Application Publication
(10) Pub. No.: US 2026/0089452 A1
(43) Pub. Date: Mar. 26, 2026

(54) METHOD AND SYSTEM FOR MEASURING AUDIO POP AND CLICK SOUNDS

(71) Applicant: SKYWORKS SOLUTiONS, INC., Irvine, CA (US)

(72) Inventor: Samuel Jacob Peters, II, Beaverton, OR (US)

(21) Appl. No.: 19/220,182

(22) Filed: May 28, 2025

Related U.S. Application Data
(60) Provisional application No. 63/654,138, filed on May 31, 2024.

(51) Int. Cl. H04R 29/00; G06N 20/00

(52) U.S. Cl. CPC H04R 29/00; G06N 20/00

(57) ABSTRACT

A system for measuring the objectionability of an audio processing technique or the objectionability of pop and click noises is presented. The system includes an audio processing circuit configured to produce an audio signal or receive the audio signal and to optionally apply a noise cancellation technique to the audio signal to produce a processed signal, and to output the audio signal or processed signal as an output signal; and an AI system configured to receive the output signal and determine a rating of an effectiveness of the noise cancellation technique or a rating of an objectionability of the output signal, the AI system determining the rating based on data including a statistically significant quantity of audio sample objectionability ratings.

### CROSS-REFERENCE TO RELATED APPLICATIONS

This application claims priority under 35 U.S. C. § 119(e) to U.S. Provisional Patent Application 63/654,138, titled METHOD AND SYSTEM FOR MEASURING AUDIO POP AND CLICK SOUNDS, filed on May 31, 2024, which is hereby incorporated by reference in its entirety for all purposes.

### BACKGROUND

### 1. Field of the Disclosure

At least one example in accordance with the present disclosure relates generally to measuring the pop and click noises in audio devices and audio signals.

### 2. Discussion of Related Art

Audio devices are used to listen to sounds. Audio devices include earpieces, headphones, telephones, and so forth. For human listeners, the quality of audio can be an important factor in the ability to understand the contents of the audio signal and/or appreciate any aesthetic characteristics of the audio signal (as with music, for example).

### SUMMARY

According to at least one aspect of the present disclosure, a system for measuring the objectionability of an audio processing technique is presented, comprising: an audio processing circuit configured to produce an audio signal or receive the audio signal and to optionally apply a noise cancellation technique to the audio signal to produce a processed signal, and to output the audio signal or processed signal as an output signal; and an AI system configured to receive the output signal and determine a rating of an effectiveness of the noise cancellation technique or a rating of an objectionability of the output signal, the AI system determining the rating based on data including a statistically significant quantity of audio sample objectionability ratings.

In some examples, the AI system is trained based on the statistically significant quantity of audio sample objectionability ratings. In some examples, the statistically significant quantity of audio sample objectionability ratings is produced by generating a plurality of audio samples, at least one of the audio samples of the plurality of audio samples including a respective pop and click sound, providing the plurality of audio samples to a plurality of human beings, and receiving the statistically significant quantity of audio sample objectionability ratings from the plurality of human beings. In some examples, the AI system is trained based on a set of predetermined characteristics of the plurality of audio samples, wherein the predetermined characteristics include one or more of the cause of the respective pop or click sound, a voltage, a current, a power, a frequency, a voltage rail, or a number of respective pop and click sounds. In some examples, the AI system is trained based on a set of predetermined characteristics of the plurality of human beings, the predetermined characteristics including one or more of demographic information, audio equipment used to listen to the plurality of audio samples, or method by which the plurality of human beings received the plurality of audio samples. In some examples, the statistically significant quantity of audio sample objectionability ratings are rated by each human being of the plurality of human beings according to a predetermined scale of objectionability. In some examples, the audio signal generator is coupled to the audio processing circuit and to the AI system.

According to at least one aspect of the present disclosure, a method of training a machine learning (ML) algorithm is presented, comprising: generating a plurality of audio samples, each audio sample having one or more pop and click sounds; providing the plurality of audio samples to a plurality of people responsive to generating the plurality of audio samples; instructing the plurality of people to rate the audio samples of the plurality of audio samples on a predetermined scale based on the objectionability of the one or more pop and click sounds responsive to providing the plurality of audio samples to the plurality of people; receiving a plurality of ratings from the plurality of people responsive to instructing the plurality of people to rate the audio samples of the plurality of audio samples; and providing the plurality of ratings to the ML algorithm.

In some examples, the method further comprises characterizing each audio sample of the plurality of audio samples based on at least the cause of the one or more pop and click sounds responsive to generating the plurality of audio samples. In some examples, characterizations of each audio sample are provided to the ML algorithm. In some examples, the method further comprises characterizing each person of the plurality of people based on one or more of demographic information or audio hardware used to listen to audio samples of the plurality of audio samples, responsive to providing the plurality of audio samples to the plurality of people. In some examples, characterizations of each person are provided to the ML algorithm. In some examples, the method further comprises providing at least one new audio sample to the ML algorithm responsive to providing the plurality of ratings to the ML algorithm, the at least one new audio sample having received processing to alter at least one pop and click sound of the at least one new audio sample, and, determining an objectionability of the at least one pop and click sound responsive to providing the at least one new audio sample to the ML algorithm. In some examples, the method further comprises determining a processing rating for the processing used to alter the at least one pop and click sound responsive to determining an objectionability of the at least one pop and click sound, the processing rating being between a first predetermined rating and a second predetermined rating.

According to at least one aspect of the present disclosure, a non-transitory computer-readable medium containing thereon instructions for instructing at least one processor to generate a rating of a noise cancellation technique, the instructions instructing the at least one processor to: generate a plurality of audio samples, each audio sample having one or more pop and click sounds; provide the plurality of audio samples to a plurality of people responsive to generating the plurality of audio samples; instruct the plurality of people to rate the audio samples of the plurality of audio samples on a predetermined scale based on the objectionability of the one or more pop and click sounds responsive to providing the plurality of audio samples to the plurality of people; receive a plurality of ratings from the plurality of people responsive to instructing the plurality of people to rate the audio samples of the plurality of audio samples; and provide the plurality of ratings to the ML algorithm.

In some examples, the instructions further instruct the at least one processor to characterize each audio sample of the plurality of audio samples based on at least the cause of the one or more pop and click sounds responsive to generating the plurality of audio samples. In some examples, each characterization of each audio sample is provided to the ML algorithm. In some examples, the instructions further instruct the at least one processor to characterize each person of the plurality of people based on one or more of demographic information or audio hardware used to listen to audio samples of the plurality of audio samples responsive to providing the plurality of audio samples to the plurality of people. In some examples, the instructions further instruct the at least one processor to provide at least one new audio sample to the ML algorithm responsive to providing the plurality of ratings to the ML algorithm, the at least one new audio sample having received processing to alter at least one pop and click sound of the at least one new audio sample, and determine an objectionability of the at least one pop and click sound responsive to providing the at least one new audio sample to the ML algorithm. In some examples, the instructions further instruct the at least one processor to determine a processing rating for the processing used to alter the at least one pop and click sound responsive to determining an objectionability of the at least one pop and click sound, the processing rating being between a first predetermined rating and a second predetermined rating.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates an audio system according to an example;

FIG. 2 illustrates a process according to an example;

FIG. 3 illustrates a process according to an example; and

FIG. 4 illustrates a system for training an AI according to an example.

### DETAILED DESCRIPTION

Audio signals can experience pops and clicks due to characteristics of the audio circuitry used to produce or render the signal into an audible form. Pops and clicks may be caused by a wide array of different things, including discontinuities in the output signal, powering the audio system on and/or off, and so forth. For example, it is not uncommon to hear a loud, irregular crackling and popping noise when plugging an audio jack into an audio port. Likewise, it is not uncommon to hear similar sounds when starting playback of an audio signal. In some examples, these pop and click noises may be caused by the audio system switching between amplifiers, power rails, output paths, and so forth.

Traditionally, audio engineers have determined the quality of an audio system based on how well the system reproduces the input audio. In this context, pops and clicks may occur in playback and may be compared to the “ideal” output signal (which may be identical to the input signal). The difference between the ideal signal and the output signal may be the error, and the lower the error, the better the performance of the system. For example, some algorithms may measure the power output (or the spectrum of power output) of the output signal and compare it to the ideal signal to determine the quality of the output signal.

However, existing methods of measuring the quality of the output signal and/or the objectionability of pop and click sounds in the audio depend on measuring objective elements, such as the power of a signal, the energy of the signal, harmonic or frequency content of a signal (or power and/or energy of frequency components), and so forth.

Aspects of this disclosure relate to methods and systems for measuring the objectionability of pop and click sounds in audio signals, and evaluating the effectiveness of methods and systems designed to reduce or remove pop and click sounds. According to aspects of this disclosure, pop and click sounds may be recorded, their origins (e.g., causes) noted, and various processing algorithms applied to the pop and click sounds to reduce or eliminate the sounds. The resulting audio output may be rated by human beings (e.g., through crowd-sourcing) according to the subjective objectionability of the pop and click sounds (possibly including both before and after processing is applied to the audio signal) based on the perspective of the human user rating the audio output. The ratings provided by humans, as well as other data, may be provided to a machine learning algorithm (“ML algorithm”) which may, in turn, evaluate other audio processing and other pop and click sounds. The ML algorithm may, in some examples, be configured to assign a score to a given processing algorithm reflecting the processing algorithm's effectiveness at removing objectionable pops and clicks. In some examples, aspects of this disclosure may be used to measure the ability of a particular circuit or algorithm to inject less pop and click noise into an audio signal when generating the audio signal (e.g., rather than removing the pop and click noises after the audio signal is initially generated).

Thus, aspects of this disclosure relate to methods and systems that determine the objectionability of pop and click noises based on the beliefs and preferences of actual humans, rather than by using traditional metrics.

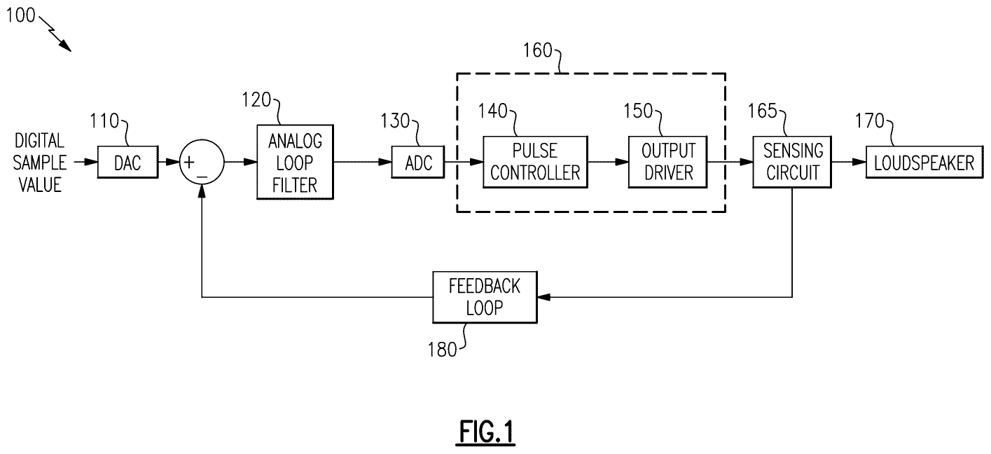

FIG. 1 illustrates an audio system 100 according to an example. The audio system 100 includes a digital-to-analog converter 110 (“DAC 110”), an analog loop filter 120, an analog-to-digital converter 130 (“ADC 130”), a driver 160 having a pulse controller 140 and an output driver 150, a sensing circuit 165, a loudspeaker 170, and a feedback loop 180.

The DAC 110 converts the digital sample values into an analog audio signal. The analog audio signal is then passed from the DAC 110 to an analog loop filter 120 for filtering prior to being sent to an analog-to-digital converter (ADC) 130. In some embodiments, the ADC 130 may be a successive approximation register (SAR) ADC. A pulse controller 140 receives a digital signal from the ADC 130, and outputs a pulse train signal to the output driver 150. The output driver 150 may then output a drive signal to the load of a loudspeaker 170 for reproducing the audio signal corresponding to the received digital sample values. In some embodiments, the output driver 150 may output a differential signal with the respective signal lines being connected across the loudspeaker load such that the loudspeaker 170 is driven with a push-pull topology.

The amplifier 100 includes a sensing circuit 165 that is configured to guide a portion of the drive signal output from the output driver 150 back into the analog loop filter 120 via a feedback loop 180, for example by using sense resistors. The feedback loop 180 may then be used to provide negative feedback error correction in the amplifier 100 using a subtractor summing circuit to provide a signal corresponding to the difference between the analog audio signal output by the DAC 110 and the drive signal that arrives at the subtractor from the sensing circuit 165 and the feedback loop 180, with the summed signal being input into the analog loop filter 120.

Various elements of the audio system 100 may produce pops and clicks. For example, the output driver 150 may be configured to switch between different voltage supply rails depending on the output power required to produce the output audio signal. Switching between the voltage supply rails may create a discontinuity in the output voltage of the output driver 150, which may produce a pop or click at the loudspeaker 170. Likewise, amplifiers or other circuit elements (e.g., in the driver 160, the ADC 130 or DAC 110, and so forth) may switch between voltage supply rails or may clip or otherwise experience discontinuities which may cause pops and clicks. Providing power to the audio system 100 or removing power from the audio system 100 may also cause discontinuities that may produce pops and clicks. In some examples ambient noise (e.g., ambient radiation) may produce pop and click noises, and internal parasitic capacitances and inductances may also produce pop and click noises.

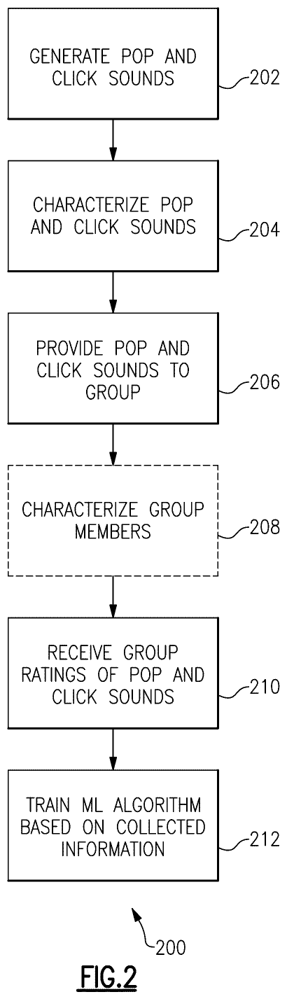

FIG. 2 illustrates a process 200 for training a machine learning algorithm (“ML algorithm”) to rate the objectionability of pop and click noises according to an example.

At act 202, pop and click noises are generated using one or more audio devices. For example, the audio system 100 of FIG. 1 may be manipulated to produce pop and click noises by controlling the voltage rail connections, turning it on and off, providing ambient radiation or interference, clipping the amplifiers, and so forth. When generating the pop and click sounds, various audio samples may be used or the pop and click sounds may be generated on their own. For example, when using an audio sample, the pop and click sounds may be generated while the audio sample is playing (e.g., the audio sample could be a song, podcast, or other audio signal). Likewise, in some examples, the pop and click sounds may be generated while the audio system 100 is in a quiescent state (which may still be considered an audio sample). Furthermore, when generating the pop and click sounds, the user may control how and when the sounds are generated by forcing the conditions which cause pops and clicks to occur. In this way, the user may know the source of a given pop and click sound. In some examples, multiple versions of the same audio sample may be generated, where each audio sample has a different pop and click sound corresponding to a different noise cancellation algorithm. For example, a first audio sample having a first pop and click sound may be a raw audio sample that has not undergone any processing. Then the first audio sample may be processed one or more times by one or more noise cancellation algorithms to reduce or otherwise modify (e.g., increase, attenuate, scale, downsample, and so forth) the raw audio sample, including the pop and click sound. In some examples, the audio samples may include signals without any pop and click sounds in them. In some examples, multiple pop and click sounds may be in a single audio sample. The process 200 may then continue to act 204.

At act 204, the pop and click sounds may be categorized according to characteristics of the pop and click sounds and/or accompanying audio samples. Characteristics may include frequency, voltage, current, power, spectral density, the type of pop and click sound, the origin (or cause) of the sound (e.g., radiation, switching voltage rails), the characteristics of the audio sample (e.g., what frequencies, sounds, and so forth, were being produced, what was the power of the audio sample, and so forth), power supply levels, the ideal output signal (e.g., what the signal would sound like without pop and click noises), when the pop and click occurs in the audio sample, the noise cancellation algorithm used on the audio sample, whether the audio sample contains any pop and click sounds and/or the number of pop and click sounds contained in a given audio sample, and so forth. The process 200 may then continue to act 206.

At act 206, the audio samples and/or pop and click sounds may be provided to a group of people. The people may be selected based on common features or may be selected to represent a given population or demographic group (e.g., 16-30 year olds). The people may also be selected based on the audio equipment they are using to listen to the pop and click sounds, and so forth. In some examples, the group of people may be compensated for their work. In some examples, the group of people may be crowd sourced, for example, via an online service that allows people to perform tasks in exchange for compensation. The group members may be instructed to respectively rate the audio samples according to how objectionable the respective group members find the pop and click sounds in a given audio sample to be. The group members may be provided with a scale of objectionability (e.g., 1-10, 1-100, 1-5, A-F, and so forth). The group members may be asked to provide descriptions of how objectionable the pop and click sounds were, and the descriptions may be analyzed to determine an objectionability on a scale. The process 200 may then continue to act 208.

Act 208 may, in some examples, be optional. In act 208, the group members may be categorized based on their characteristics. Characteristics may include demographic information, job or work information, audio equipment used to listen to the audio samples, the types of audio they listen to (e.g., music, podcasts, movies, soundtracks, and so forth), geographic location, hearing ability (e.g., level of deafness, presence of tinnitus, and so forth), and so forth. The process 200 may then continue to act 210.

At act 210, the user may receive the ratings from the group members. For example, if two-thousand group members rated audio samples, the user may receive those ratings and identifying data indicating which group member rated which audio samples. The user may also receive any other information collected or used in categorization (e.g., characteristics of the audio samples, the pop and clicks, and/or the group members). The user may collate the data into one or more databases. In some examples, the user may receive a statistically significant quantity of ratings of the audio samples and/or pop and click sounds. The process 200 may then continue to act 212.

At act 212, the user may train a ML algorithm based on the data in the one or more databases. For example, the ML algorithm may be trained on the ratings of the audio samples, and the characteristics of the audio samples and/or the group members who rated the audio samples, to classify the objectionability of a given pop and click sound in a given context, and to provide an output representation (e.g., a value on a scale, such as a scale from 1 to 10) of the objectionability of a given pop and click sound in an audio sample. The ML algorithm may be any type of ML algorithm and may use any type or types of ML techniques, for example, neural networks, supervised or unsupervised learning, reinforcement learning, and so forth.

In the foregoing example, the process 200 may use some or all of the characteristics (of the audio sample, group members, and so forth), but it will be understood that the process 200 need not use all of the characteristics.

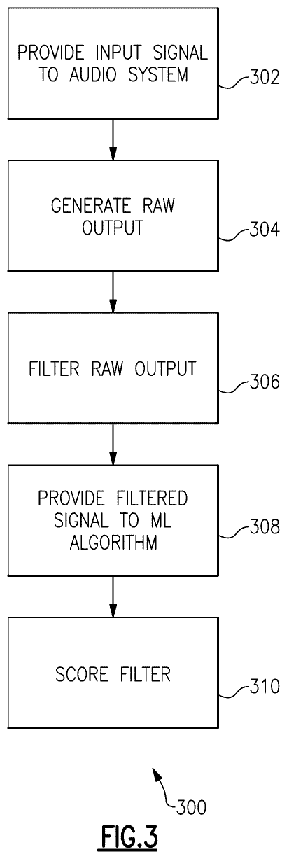

FIG. 3 illustrates a process 300 for testing noise cancellation techniques using a ML algorithm according to an example.

At act 302, an input signal is provided to an audio system (e.g., an input signal to the audio system 100 of FIG. 1). The input signal may, for example, be a modulated signal that the audio system will demodulate, an encoded signal the audio system will decode, an analog or digital signal the audio system will convert to an audible sound signal, and so forth. The process 300 may then continue to act 304.

At act 304, the audio system generates a raw output (which may be an audible sound signal) based on the configuration and characteristics of the audio system itself. For example, if the audio system is particularly susceptible to radiation, the raw output may include some amount of pop and click noises due to interference from radiation. In some examples, the audio system may shift between voltage rails for one or more components of the system, resulting in pop and click noises, and so forth. The process 300 may then continue to act 306.

At act 306, the system filters or processes the raw output. The filtering or processing applied to the raw output may include noise cancellation techniques (e.g., algorithms, filtering techniques, and so forth) designed to remove pop and click noises from the raw output. One or more noise cancellation techniques and/or other filtering and/or processing techniques may be applied to the raw output, for example to address different kinds of pop and click sounds (e.g., pop and click noises originating from different causes or sources). The resulting filtered raw output may have less audible pop and click noises as the result of the processing or filtering. The process 300 may then continue to act 308.

At act 308, the filtered raw output (and/or raw output) may be provided to the machine learning algorithm. The filtered raw output may be provided in analog or digital form, and may be an audible sound signal or may be an encoding of such a signal for more convenient handling by the ML algorithm (e.g., instead of providing an audible sound signal, the filtered raw output could be sampled, the samples converted to digital values, and the resulting sequence of digital values provided to the ML algorithm for evaluation). The ML algorithm may be an algorithm trained to identify the objectionability of the pop and click sounds in the filtered raw output, for example, the ML algorithm may be an algorithm trained as described with respect to FIG. 2. The process 300 may then continue to act 310.

At act 310, the ML algorithm may analyze and score the processing or filtering techniques based on a determination (also made by the ML algorithm) of the objectionability of the pop and click sounds in the filtered raw output. The ML algorithm may provide an output indicative of the effectiveness of the processing or filtering techniques and/or the objectionability of the pop and click sounds the ML algorithm analyzed.

In some examples, the filtering or design of the circuit may already incorporate changes to the audio signal to reduce or change the pop and click sounds. In some examples, the output of the system may be compared not to a raw output but to an output produced by a different circuit or algorithm, thereby allowing comparison of specific pop and click sound mitigation techniques and systems.

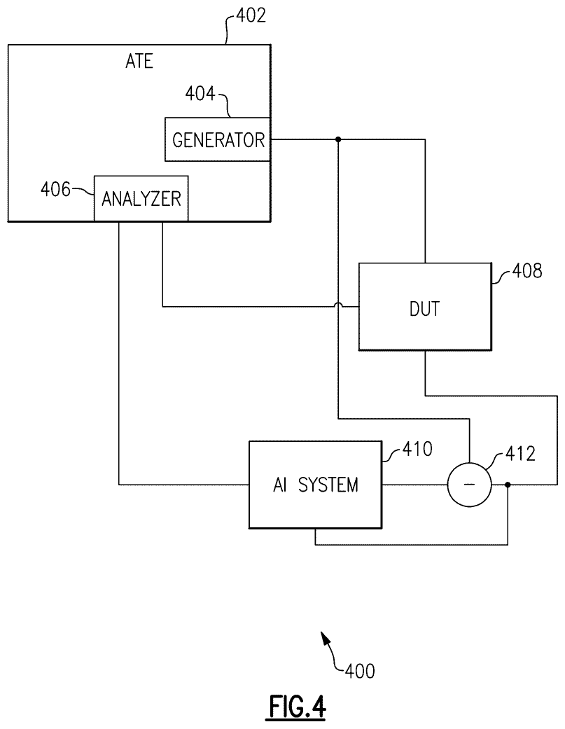

FIG. 4 illustrates an audio test system 400 (“system 400”) according to an example. The system 400 includes Audio Test Equipment 402 (“ATE 402”) having a generator 404 and/or an analyzer 406, a device-under-test 408 (“DUT 408”), an AI system 410, and an optional summing node 112.

The generator 404 is coupled to the DUT 408, the AI system 410, and/or (optionally) the summing node 412. In some examples, if the summing node 412 is not included, the generator 404 may be coupled directly to the AI system 410. The analyzer 406 is coupled to the DUT 408 and the AI system 410. In some examples, a first connection of the analyzer 406 is coupled to the DUT 408, and a second connection of the analyzer 406 is coupled to the AI system 410. The DUT 408 may be coupled to the AI system 410 as well.

The ATE 402 is configured to generate input signals for the DUT 408 and/or AI system 410, and to analyze the output of the DUT 408. The generator 404 may provide an analog or digital input signal (for example, the input signal may be an audio signal the DUT 408 will filter and/or process or instructions to generate and/or output an audio signal to the analyzer 406 and/or summing node 412 and/or AI system 410). The generator 404 may also provide the input signal to the AI system 410 and/or summing node 412.

The DUT 408 may be an audio system, such as the audio system 100 of FIG. 1. The DUT 408 is configured to receive the input signal and to generate an output signal based on the input signal. The output signal may then be provided to the analyzer 406, the summing node 412, and/or the AI system 410. The DUT 408 may filter and/or process the input signal to generate the output signal. That is, the DUT 408 may, in some examples, apply noise cancellation techniques when generating the output signal to attenuate or adjust pop and click sounds that might be present in the output signal due to the characteristics of the DUT 408.

The analyzer 406 is configured to analyze the output signal from the DUT 408 using traditional metrics and techniques. The analyzer 406 may be configured to forward the output signal to the AI system 410 and/or to provide the AI system 410 with an analysis of the effectiveness of the noise cancellation techniques used to eliminate pop and click noises used by the DUT 408. The analysis provided by the Analyzer 406 may be based on traditional metrics.

The summing node 412 may receive the signal from the generator 404 and the signal from the DUT 408, and may determine the difference between those two signals (e.g., may subtract one signal from the other). In some examples, determining the difference between the two signals may result in a pop and click noise signal that contains only and/or substantially (e.g., a majority) pop and click sounds. For example, the difference may subtract the desired audio signal leaving only the pop and click noises from the signal produced by the generator 404 and/or the signal produced by the DUT 408. The difference signal created by the summing node 412 may be provided by the summing node 412 to the AI system 410 as yet another data point and/or point of comparison the AI system 410 may use to determine objectionability of pop and click sounds.

The AI system 410 is configured to receive the input signal, the output signal, the difference signal, and/or any other data (e.g., the analysis) from the DUT 408 and/or analyzer 406. The AI system may include a ML algorithm (e.g., one trained using the process 200 of FIG. 2) to generate a score of the noise cancellation techniques and/or other filtering or processing performed by the DUT 408 (e.g., as described with respect to the process 300 of FIG. 3). The AI system 410 may provide an output indicative of the score assigned to the noise cancellation techniques and/or other filtering or processing. The AI system 410 may also provide a score of the objectionability of the pop and click noises in the signals (e.g., input and/or output signals) received by the AI system 410.

In some examples, the generator 404 may output a signal that includes pop and click noises, and the DUT 408 may be configured to apply noise cancellation techniques to that signal to eliminate the pop and click sounds included in the signal.

Examples of the methods and systems discussed herein are not limited in application to the details of construction and the arrangement of components set forth in the description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Various controllers, such as an ASIC, FPGA, server, microprocessor or processor, and so forth, may execute various operations discussed above. Using data stored in associated memory and/or storage, the controller also executes one or more instructions stored on one or more non-transitory computer-readable media, which the controller may include and/or be coupled to, that may result in manipulated data. In some examples, the controller may include one or more processors or other types of controllers. In one example, the controller is or includes at least one processor. In another example, the controller performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A system for measuring an objectionability of an audio processing technique or an objectionability of pop and click noises, comprising:
an audio processing circuit configured to produce an audio signal or receive the audio signal and to optionally apply a noise cancellation technique to the audio signal to produce a processed signal, and to output the audio signal or processed signal as an output signal; and
an AI system configured to receive the output signal and determine a rating of an effectiveness of the noise cancellation technique or a rating of an objectionability of the output signal, the AI system determining the rating based on data including a statistically significant quantity of audio sample objectionability ratings.

2. The system of claim 1 wherein the AI system is trained based on the statistically significant quantity of audio sample objectionability ratings.

3. The system of claim 1 wherein the statistically significant quantity of audio sample objectionability ratings is produced by
generating a plurality of audio samples, at least one audio sample of the plurality of audio samples including a respective pop and click sound,
providing the plurality of audio samples to a plurality of human beings, and
receiving the statistically significant quantity of audio sample objectionability ratings from the plurality of human beings.

4. The system of claim 3 wherein the AI system is trained based on a set of predetermined characteristics of the plurality of audio samples, wherein the set of predetermined characteristics include one or more of
a cause of the respective pop or click sound,
a voltage,
a current,
a power,
a frequency,
a voltage rail, or
a number of respective pop and click sounds.

5. The system of claim 3 wherein the AI system is trained based on a set of predetermined characteristics of the plurality of human beings, the set of predetermined characteristics including one or more of
demographic information,
audio equipment used to listen to the plurality of audio samples, or
method by which the plurality of human beings received the plurality of audio samples.

6. The system of claim 3 wherein the statistically significant quantity of audio sample objectionability ratings are rated by each human being of the plurality of human beings according to a predetermined scale of objectionability.

7. The system of claim 1 wherein an audio signal generator is coupled to the audio processing circuit and to the AI system.

8. A method of training a machine learning (ML) algorithm, comprising:
generating a plurality of audio samples, each audio sample having one or more pop and click sounds;
providing the plurality of audio samples to a plurality of people responsive to generating the plurality of audio samples;
instructing the plurality of people to rate audio samples of the plurality of audio samples on a predetermined scale based on objectionability of the one or more pop and click sounds responsive to providing the plurality of audio samples to the plurality of people;
receiving a plurality of ratings from the plurality of people responsive to instructing the plurality of people to rate the audio samples of the plurality of audio samples; and
providing the plurality of ratings to the ML algorithm.

9. The method of claim 8 wherein the method further comprises characterizing each audio sample of the plurality of audio samples based on at least a cause of the one or more pop and click sounds responsive to generating the plurality of audio samples.

10. The method of claim 9 wherein characterizations of each audio sample are provided to the ML algorithm.

11. The method of claim 8 wherein the method further comprises characterizing each person of the plurality of people based on one or more of demographic information or audio hardware used to listen to audio samples of the plurality of audio samples, responsive to providing the plurality of audio samples to the plurality of people.

12. The method of claim 11 wherein characterizations of each person are provided to the ML algorithm.

13. The method of claim 8 further comprising providing at least one new audio sample to the ML algorithm responsive to providing the plurality of ratings to the ML algorithm, the at least one new audio sample having received processing to alter at least one pop and click sound of the at least one new audio sample, and, determining an objectionability of the at least one pop and click sound responsive to providing the at least one new audio sample to the ML algorithm.

14. The method of claim 13 further comprising determining a processing rating for the processing used to alter the at least one pop and click sound responsive to determining an objectionability of the at least one pop and click sound, the processing rating being between a first predetermined rating and a second predetermined rating.

15. A non-transitory computer-readable medium containing thereon instructions for instructing at least one processor to generate a rating of a noise cancellation technique, the instructions instructing the at least one processor to:
generate a plurality of audio samples, each audio sample having one or more pop and click sounds;
provide the plurality of audio samples to a plurality of people responsive to generating the plurality of audio samples;
instruct the plurality of people to rate audio samples of the plurality of audio samples on a predetermined scale based on an objectionability of the one or more pop and click sounds responsive to providing the plurality of audio samples to the plurality of people;
receive a plurality of ratings from the plurality of people responsive to instructing the plurality of people to rate the audio samples of the plurality of audio samples; and
provide the plurality of ratings to a machine learning (ML) algorithm.

16. The non-transitory computer-readable medium of claim 15 wherein the instructions further instruct the at least one processor to characterize each audio sample of the plurality of audio samples based on at least a cause of the one or more pop and click sounds responsive to generating the plurality of audio samples.

17. The non-transitory computer-readable medium of claim 15 wherein each characterization of each audio sample is provided to the ML algorithm.

18. The non-transitory computer-readable medium of claim 15 wherein the instructions further instruct the at least one processor to characterize each person of the plurality of people based on one or more of demographic information or audio hardware used to listen to audio samples of the plurality of audio samples responsive to providing the plurality of audio samples to the plurality of people.

19. The non-transitory computer-readable medium of claim 15 wherein the instructions further instruct the at least one processor to provide at least one new audio sample to the ML algorithm responsive to providing the plurality of ratings to the ML algorithm, the at least one new audio sample having received processing to alter at least one pop and click sound of the at least one new audio sample, and determine an objectionability of the at least one pop and click sound responsive to providing the at least one new audio sample to the ML algorithm.

20. The non-transitory computer-readable medium of claim 19 wherein the instructions further instruct the at least one processor to determine a processing rating for the processing used to alter the at least one pop and click sound responsive to determining an objectionability of the at least one pop and click sound, the processing rating being between a first predetermined rating and a second predetermined rating.
